(19) United States
(12) Patent Application Publication
(10) Pub. No.: US 2009/0117523 A1
(43) Pub. Date: May 7, 2009

(54) Optical hand drawing plate

(76) Inventor: Chi-Shih Lai, Panchiao (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/979,386

(22) Filed: Nov. 2, 2007

(51) Int. Cl. G09B 11/04

(52) U.S. Cl. 434/88

(57) ABSTRACT

An optical hand drawing plate includes a body and a backlight module. The body has a concave portion and an input portion corresponding to one side of the concave portion. The backlight module is mounted in the concave portion and includes a light guide plate, a background plate and a light emitting assembly. An insertion space is formed between the light guide plate and the background plate and corresponds to the input portion. Basing on the structure of the present invention, a picture can be inserted in the insert space between the light guide plate and the background plate through the input portion, and a user can directly draw patterns shown on the picture. A light source is provided for the light guide plate via the light emitting assembly, thereby the optical hand drawing plate has a special visual effect.

### BACKGROUND OF THE INVENTION

1. Field of the Invention

The present invention relates to a hand drawing plate, and more particular to a hand drawing plate for drawing a picture.

2. Description of Related Art

Conventional drawing books always have graphics or characters on paper thereof so that children can directly draw on the papers along profiles of the graphics or characters. However, since the drawing books cannot be used repeatedly after the paper provided to be drawn has been drawn on, it causes a waste of paper.

Another kind of conventional drawing product is a magnetic handwriting plate with a magnetic plate surface. Users can directly draw on the plate surface by a magnetic writing tool. During drawing, the plate surface absorbs magnetic powder on positions where the writing tool contacts with the plate surface. So drawn tracks formed by the magnetic powder can be retained on the plate surface after drawing. The plate also has a degaussing design for cleaning up the magnetic powder absorbed on the plate surface basing on degaussing action. Though the magnetic handwriting plate can be used repeatedly, children cannot directly draw an aim object on the magnetic handwriting plate, which brings difficulty to study graphics or characters through the magnetic handwriting plate.

In the two kinds of drawing products described above, the drawing books can be directly drawn in by different pencils, but have no backlight light source to enhance color effects of the pencils. Similarly, though the magnetic handwriting plates can be used repeatedly comparing with the drawing books, the plates also have no backlight light source to provide a lighting effect.

Thus, for overcoming the shortcomings of the above products, a hand drawing plate as shown in FIG. 1 is enclosed. The hand drawing body 9 in FIG. 1 has a plate surface 91 disposed on a surface thereof. A transparent film 95 is placed on the plate surface 91 via an engagement of protruding portions 951 of the transparent film 95 and slots 952 in the body 9, so that the transparent film 95, relative to the hand drawing body 9, can be opened. In FIG. 1, when the transparent film 95 is opened, a picture 93 can be inserted between the transparent film 95 and the plate surface 91. So after covering the picture 93 with the transparent film 95, the users can directly draw graphics of the picture 93 on a surface of the transparent film 95. Moreover, the drawn graphics can be cleaned up by wipe tools so that the transparent film 95 can be used repeatedly.

Though the hand drawing plate in FIG. 1 can be repeatedly used and directly drawn an aim object on, comparing with the above drawing books and the magnetic handwriting plates, the hand drawing plate in FIG. 1 also has no backlight light source to provide a special lighting effect for the drawn graphics, which cannot help to increase study interest of children.

### SUMMARY OF THE INVENTION

The object of the present invention is to provide an optical hand drawing plate which provides back lighting so that drawn pictures can show visual effects of brightness.

To achieve the above-mentioned object, an optical hand drawing plate in accordance with the present invention is provided. The optical hand drawing plate includes a body and a backlight module. The body has a concave portion and an input portion corresponding to one side of the concave portion. The backlight module has an insertion space for insertion of a picture and is mounted in the concave portion. The insertion space corresponds to the input portion.

In one embodiment of the present invention, the concave portion includes a bottom and a surrounding portion surrounding the bottom, and the surrounding portion has a positioning portion.

In one embodiment of the present invention, a light beam from a light source is transmitted to pass through the backlight module. The backlight module includes a background plate, a light guide plate and at least one light emitting assembly. The background plate is mounted in the bottom, the light guide plate is mounted on the positioning portion, and the insertion space is formed between the background plate and the light guide plate. The light emitting assembly is mounted at one side of the light guide plate.

In one embodiment of the present invention, the present invention further includes a guiding portion which is mounted in the input portion and connects with the concave portion. The guiding portion has a guiding plane adjacent to a surface of the background plate in the concave portion.

The optical hand drawing plate of the present invention directly provides a light source for the light guide plate via the light emitting assembly, so that drawn pictures on the light guide plate shows a special visual effect of back lighting against the background caused by the background plate being used as a backlight light source. Furthermore, it is convenient and efficient that a picture is directly inserted into the insertion space between the light guide plate and the background plate through the input portion.

### BRIEF DESCRIPTION OF THE DRAWINGS

FIG. 1 is an exploded view of a prior hand drawing plate;

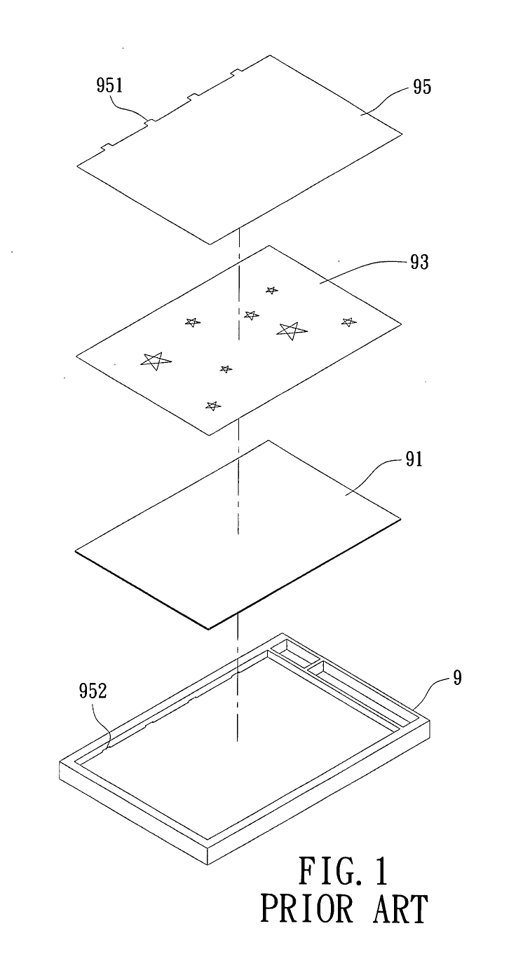

FIG. 2 is a perspective view of a first embodiment according to the present invention;

FIG. 3 is an exploded perspective view of the first embodiment according to the present invention;

FIG. 4 is a partially cross-sectional view of the first embodiment according to the present invention;

FIG. 5 is a partially enlarged view of part A in FIG. 4;

FIG. 6 is a schematic view showing that a picture is being drawn out of the first embodiment according to the present invention;

FIG. 7 is a schematic view showing the present invention in combination with a learning piece for drawing study;

FIG. 8 is a schematic view showing the present invention in combination with a learning piece and a drawing piece for rotoscoping;

FIG. 9 is a cross-sectional view showing the present invention in combination with a drawing piece;

FIG. 10 is a perspective view of a second embodiment according to the present invention; and

FIG. 11 is a partially cross-sectional view taken along lines 11-11 in FIG.

### DETAILED DESCRIPTION OF THE PREFERRED EMBODIMENTS

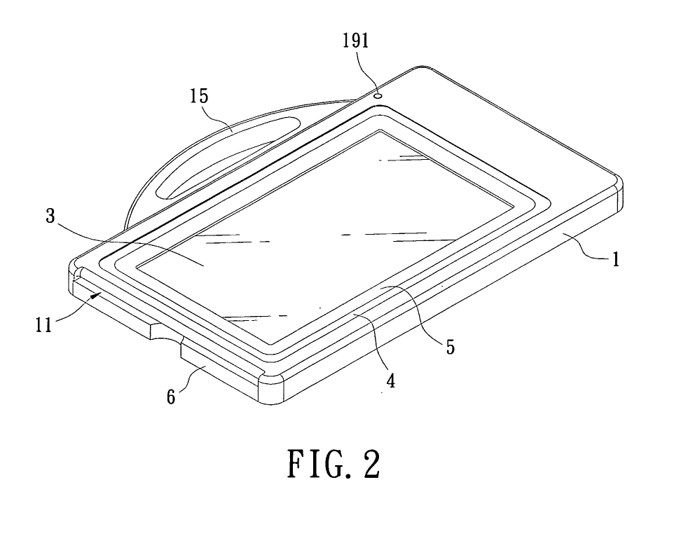

Please refer to FIG. 2 which is a perspective view of a first embodiment according to the present invention. In FIG. 2, the optical hand drawing plate mainly includes a body 1 with a backlight module which provides back lighting for patterns or characters finished by hand on a light guide plate 3. Additionally, the body 1 has an input portion 11 on one side thereof. The input portion 11 is convenient for inserting a picture (not shown) into or drawing a picture (not shown) out of the body 1, thereby a user can draw through the body 1 by hand.

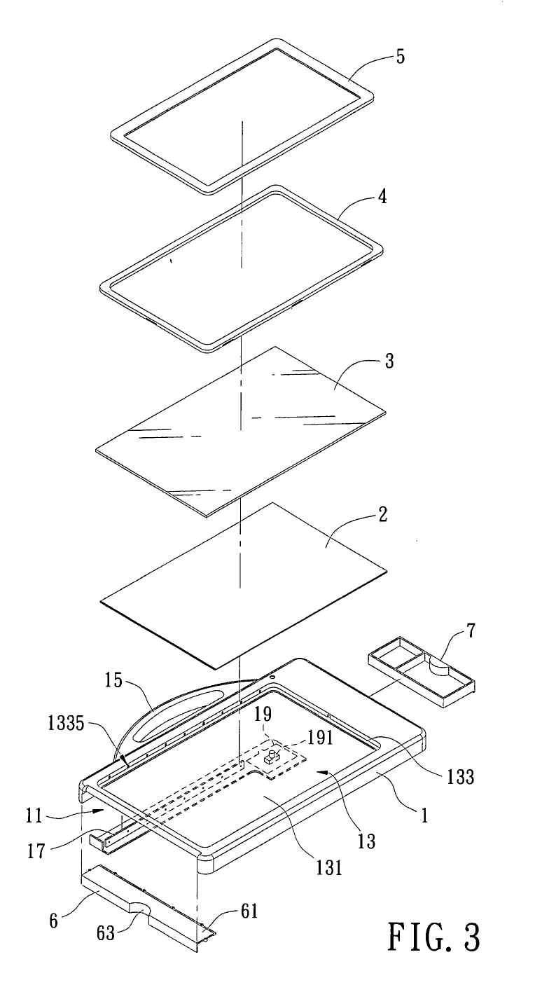

Please refer to FIG. 3 which is an exploded perspective view of the first embodiment according to the present invention. The optical hand drawing plate of the first embodiment includes a body 1, a background plate 2, a light guide plate 3, a light emitting assembly 17 and so on, wherein the background 2, the light guide plate 3 and the light emitting assembly 17 are used as a backlight module in the embodiment. The body 1 generally is a rectangle plate and has a concave portion 13 in a proper position on a surface thereof. The body 1 forms the input portion 11 on one side of the concave portion 13, which directly corresponds to the concave portion 13. Besides, a holding portion 15 is formed on another side of the body 1 to be held by the user. The concave portion 13 of the body 1 comprises a bottom 131 and a surrounding portion 133 surrounding the bottom 131. The surrounding portion 133 has a projection portion for light source 1335 made up of a plurality of through-holes.

Refer to FIG. 3 again, the input portion 11 on the side of the body 1 forms a slot. The embodiment disposes a guiding portion 6 in the input portion 11, which connects with the bottom 131 of the concave portion 13. The guiding portion 6 has a guiding plane 61 and a draw-out portion 63, wherein one side of the guiding plane 61 corresponds to the bottom 131, the other side extends out of the body 1, as shown in FIG. 2. The draw-out portion 63 is located on a side edge of the guiding plane 61 and forms a concave arched surface on the guiding plane 61.

The light emitting assembly 17 is mounted on a side edge of the concave portion 13 in the body 1. Light beams from the light emitting assembly 17 may be directly projected on the light guide plate 3 through the projection portion for light source 1335 in the concave portion 13. In the embodiment, the light emitting assembly 17 may be lamps, light-emitting diodes (LED) or cold cathode fluorescent lamps (CCFL), but not limited to those devices, and the light emitting assembly 17 also may be other light-emitting parts mounted in the body 1. The embodiment may have a plurality of light emitting assemblies 17 to enhance brightness of the light beams.

The background plate 2 is mounted on the bottom 131 in the concave portion 13. In the embodiment, the background plate 2 may be a backlight plate or a cold light plate. As for a backlight plate, the background plate 2 may be made of plastic material with a dark-colored surface to be a background for a backlight light source so as to improve a set-off effect of back lighting. If the background plate 2 is a cold light plate, light source color of the cold light plate not only may be ground color for the backlight light source, but also enhances a lighting effect of the backlight light source.

The light guide plate 3 is mounted at a side of the projection portion for light source 1335 above the background plate 2 in the concave portion 13, that is, the projection portion for light source 1335 is located between the light emitting assembly 17 and the light guide plate 3, so that the light guide plate 3 may be uniformly illuminated through the projection portion for light source 1335 by the light emitting assembly 17. Furthermore, an insertion space with a fixed interval is formed between the light guide plate 3 and the background plate 2 for insertion of a picture. The insertion space corresponds to the slot of the input portion 11.

A fixing piece 4 is mounted on the light guide plate 3 in the concave portion 13 for fixing the light guide plate 3 in the concave portion 13. A pressing piece 5 is mounted on the light guide plate 3 for fixing a piece of extra drawing paper placed on the light guide plate 3, which has a visual perspective effect. For example, the pressing piece 5 of the embodiment may fix a drawing piece on the light guide plate 3, which will be described in detail hereinafter.

The body 1 further has a control circuitry 19 mounted on a back surface thereof. The control circuitry 19 may control a power supply of the body 1 to switch on/off and control lighting of the backlight light source, such as control operation of the light emitting assembly 17, or control operation of the cold light plate at the same time when the background plate 2 is the cold light plate. The control circuitry 19 of the embodiment has a power switch 191 for switching the power supply on/off. The control circuitry 19 is supplied with power under the control of the power switch 191. The control circuitry 19 may be directly supplied with DC power by batteries, or supplied with DC power which is converted AC power to by a power adapter. When the power switch 191 is switched to an “on” position, power is supplied for the control circuitry 19, and further provided for the light emitting assembly 17. On the other hand, when the power switch 191 is switched on an “off” position, power cannot be supplied for the control circuitry 19. The power switch 191 is disposed on the body 1, protrudes from a front surface of the body 1, and connects with the control circuitry 19. Besides, the control circuitry 19 may be designed to control the light emitting assembly 17 to twinkle and shine. Detailed design of the control circuitry 10 may be readily achieved by those skilled in the art, so a detailed description of structure and work principle of the control circuitry 19 is omitted inhere.

A receiving portion 7 is inserted in one side of the body 1 to provide a receiving space for drawing tools (such as nite writer pens) and wipe tools (such as cloth). The receiving portion 7 is mounted in the body 1 in a draw-out manner.

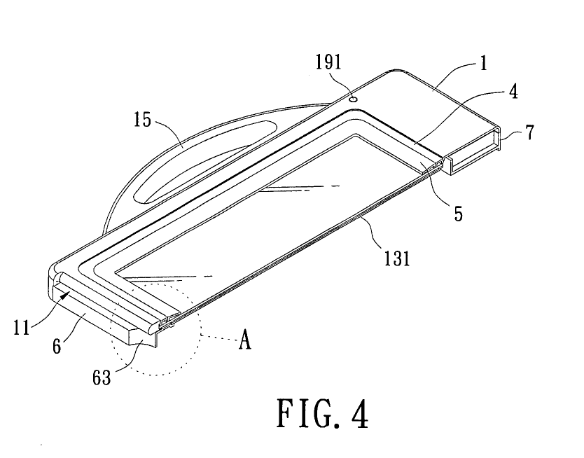

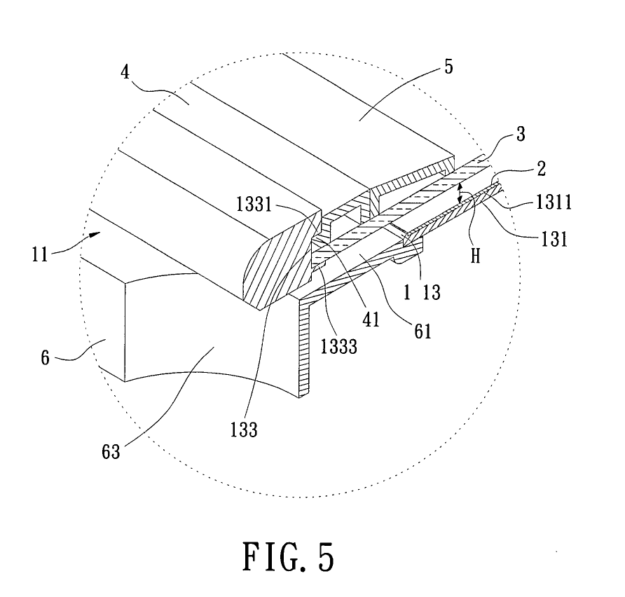

Please refer to FIG. 4 and FIG. 5, wherein FIG. 4 is a partially cross-sectional view of the first embodiment according to the present invention, and FIG. 5 is a partially enlarged view of FIG. 4. FIG. 5 shows detailed structure among the mainly portions of the present invention. The surrounding portion 133 of the body 1 further has a fastening portion 1331 and a positioning portion 1333. The fastening portion 1331 may engage with a protruding portion 41 of the fixing portion 4, and the fixing portion 4 simultaneously abuts against the light guide plate 3, thereby the light guide plate 3 is fixed between the positioning portion 1333 and the fixing piece 4. The bottom 131 further forms a concave bearing surface 1311 for receiving the background plate 2 and an inclined plane 1313 on one side adjacent to the input portion 11. The inclined plane 1313 directly connects with the guiding plane 61 of the guiding portion 6, so that a surface of the background plate 2 may be adjacent to the guiding plane 61 through the inclined plane 1313.

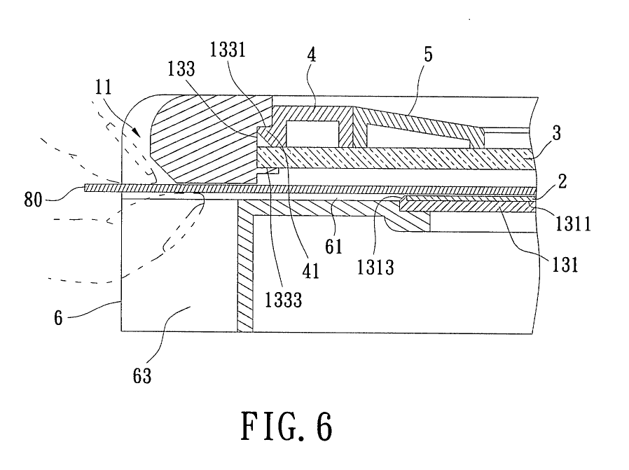

Refer to FIG. 5 again, the light guide plate 3 and the background plate 2 keep a fixed interval H therebetween to form the insertion space, thereby a picture (not shown) may be inserted between the light guide plate 3 and the background plate 2. The input portion 11 forms the slot and the slot has a slot hole adjacent to the bottom 131. So when disposed in the slot of the input portion 11, the guiding portion 6 may guide a picture inserted into the input portion 11 to the insertion space between the light guide plate 3 and the background plate 2 through the guiding plane 61 and the inclined plane 1313. Additionally, the user may insert a picture into or draw a picture out of the input portion 11 via the draw-out portion 63 which is a concave arched surface, thereby the picture is easily inserted into or drawn out of the body 1. Please refer to FIG. 6 which is a schematic view showing that a picture is being drawn out of the present invention. The picture 80 may be inserted into the input portion 11, and guided to the insertion space between the light guide plate 3 and the background plate 2 by the guiding portion 6. Similarly, when drawing the picture 80 out of the input portion 11, the user put his fingers on the concave arched surface of the draw-out portion 63, directly picks up the picture 80 by his fingers, thereby drawing the picture 80 out of the input portion 11 easily and quickly.

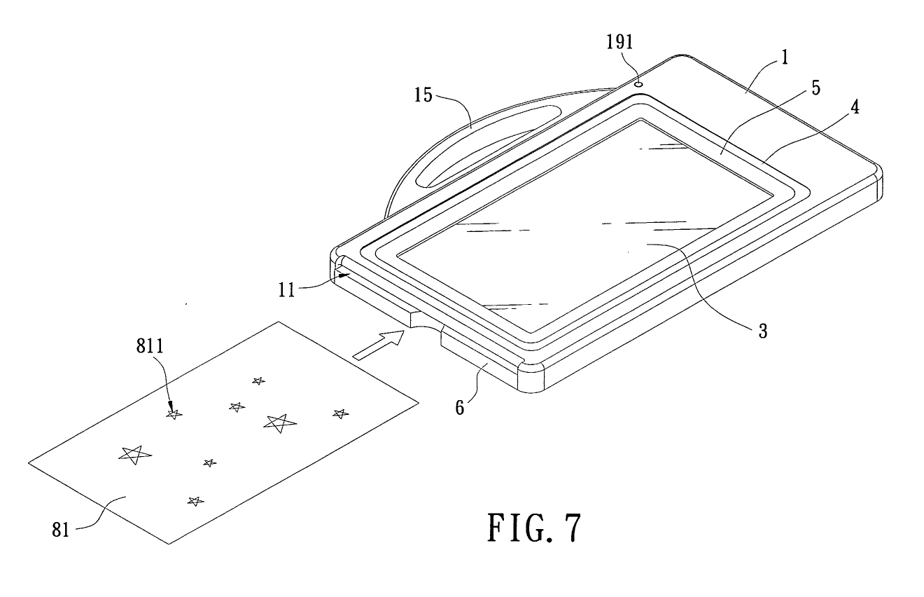

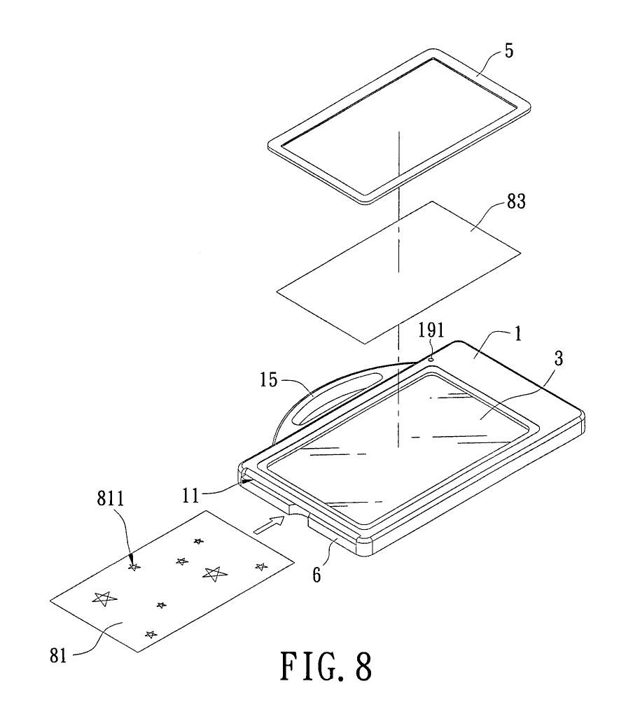

For explaining an actual operation process of the embodiment, please refer to FIG. 7 and FIG. 8, wherein FIG. 7 is a schematic view showing the first embodiment in combination with a learning piece 81 for drawing study and FIG. 8 is a schematic view showing the first embodiment in combination with the learning piece 81 and a drawing piece 83 for rotoscoping.

In FIG. 7, the user may insert the learning piece 81 via the input portion 11. The learning piece 81 is made of transparent material (such as a plastic piece) and has a surface on which patterns 811 are printed, so that the user may learn the patterns via directly drawing on the light guide plate 3. The patterns 811 may be random combinations of characters and graphics. Thus, when the learning piece 81 is inserted into the insertion space between the light guide plate 3 and the background plate 2 (as shown in FIG. 5), the user may directly draw the patterns 811 shown on the learning piece 81 on the light guide plate 3 with a nite write pen (not shown). Furthermore, the light emitting assembly 17 may be switched on via the power switch 191 to provide back lighting for the light guide plate 3, so that the finished picture drawn on the light guide plate 3 by the user shows a special visual effect of back lighting against the background caused by the background plate 2 being used as a backlight light source.

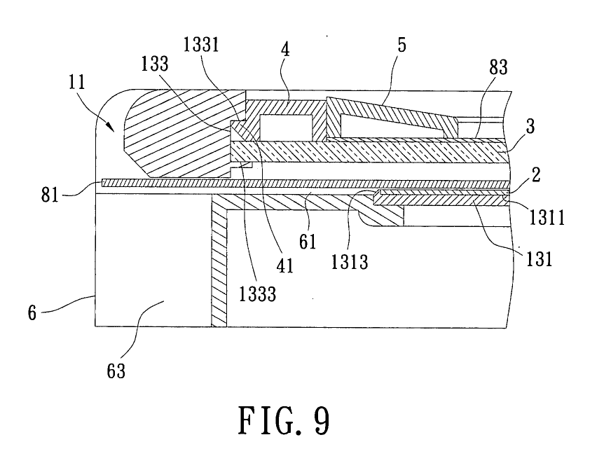

In FIG. 8, comparing with the condition in FIG. 7, besides inserting the learning piece 81 into the body 1, the drawing picture 83 is put on the light guide plate 3. The drawing picture 83 also is made of transparent material (such as drawing paper with a transparent effect). The pressing piece 5 presses on the drawing piece 83 to fix the drawing piece 83 on the light guide plate 3 without deviation, as shown in FIG. 9. So, the user may directly rotoscope the patterns 811 shown on the learning piece 81 on the drawing piece 83 with a writing pen (not shown). Furthermore, the light emitting assembly 17 may be switched on via the power switch 191 to provide back lighting which is convenient for carrying out the rotoscoping action. According, in the rotoscoping manner shown in FIG. 8, the user may easily rotoscope the patterns of the learning piece 81 on the drawing piece 83.

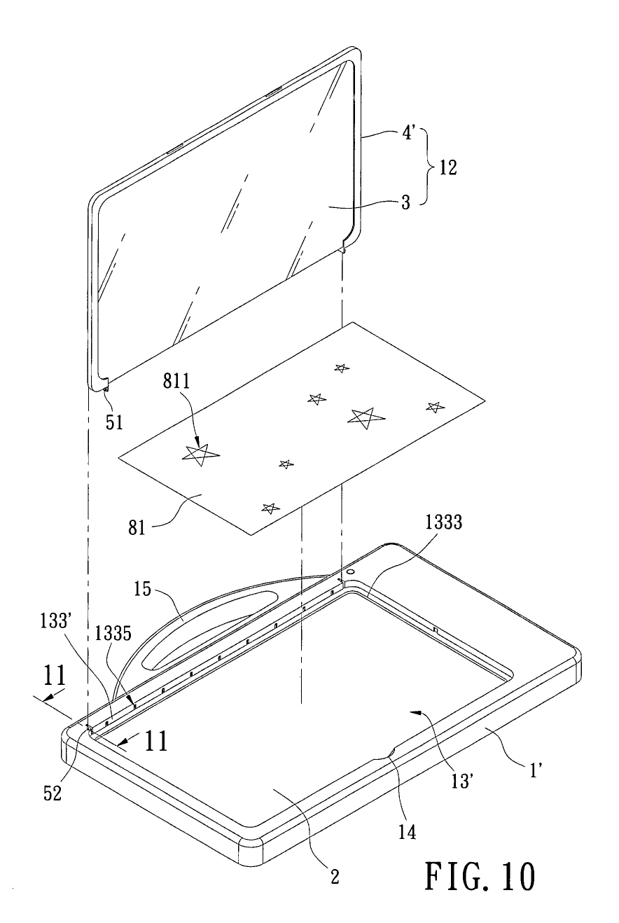

Please refer to FIG. 10 which is a perspective view of a second embodiment according to the present invention. In the first embodiment mentioned above, the learning piece 81 is put in the body 1 through the input portion 11; however, as shown in FIG. 10, the learning piece 81 is put in the optical hand drawing plate by means of opening the plate, which is a main difference between the first embodiment and the second embodiment. The second embodiment has a movable light guide module 12 for carrying out the opening action. The movable light guide module 12 includes a fixing piece 4′ and a light guide plate 3. The fixing piece 4′ is fixed on sides of the light guide plate 3 and has a first pivoted end 51.

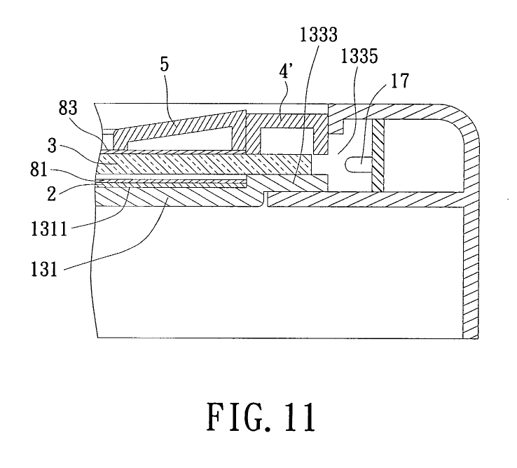

Then please refer to FIG. 10 and FIG. 11, a backlight module of the second embodiment includes the movable light guide module 12, the background plate 2 and the light emitting assembly 17. The position of the light emitting assembly 17 in the second embodiment may be the same as that in the first embodiment. The body 1′ of the second embodiment has a concave portion 13′ which comprises a bottom 131 and a surrounding portion 133′ surrounding the bottom 131. The surrounding portion 133′ has a projection portion for light source 1335 and a positioning portion 1333. The projection portion for light source 1335 is made up of a plurality of through-holes, thereby light beams from the light emitting assembly 17 pass through the projection portion for light source 1335. The background plate 2 is mounted on a concave bearing surface 1311 of the bottom 131, and the light guide plate 3 is mounted on the positioning portion 1333 of the surrounding portion 133′, so that an insertion space is formed between the light guide plate 3 and the background plate 2 for receiving a learning piece 81.

Additionally, the body 1′ further has a second pivoted end 52 engaging with the first pivoted end 51, so that the movable light guide module 12, relative to the body 1′, may be opened by the user. The second pivoted end 52 mentioned above is advantageously disposed on the surrounding portion 133′ of the concave portion 13′ of the body 1′. Thus, when the movable light guide module 12 is horizontally placed on the body 1′, the light guide plate 2 directly corresponds to the light emitting assembly 17 and is illuminated by the light emitting assembly 17. The surrounding portion 133′ has a concave opening portion 14 on one side thereof, which is convenient for opening the movable light guide module 12 directly.

In the above second embodiment, the first pivoted end 51 may be a protruding column and the second pivoted end 52 may be a hollow round hole. The movable light guide module 12, relative to the body 1′, may be opened via the engagement of the protruding column and the round hole. Of course, when the positions of the protruding column of the first pivoted end 51 and the round hole of the second pivoted end 52 are exchanged, the same effect can be achieved.

The present invention disposes a backlight module in the body. The backlight module mentioned in the above embodiment includes the background plate 2, the light guide plate 3 and a light emitting assembly 17. The embodiment uses edge-lit back lighting and disposes the light emitting assembly 17 at one side of the light emitting assembly 17. Those skilled in the art will recognize that the backlight module can be changed into a direct-lit backlight module, for example, a light source is directly located under the light guide plate 3 to take the place of the former backlight plate 2.

Consequently, the optical hand drawing plate according to the present invention is advantageous that:

1. Combining with a function of back lighting, the optical hand drawing plate can make the picture drawn on the light guide plate by hand with a special shining visual effect.

2. The optical hand drawing plate can provide a function of study, as shown in FIG. 7. The function can guide users to directly drawing patterns of the learning piece 81 on the light guide plate 3, thereby increasing study interest of the users.

3. The optical hand drawing plate can provide a function of rotoscoping, as shown in FIG. 7. The rotoscoping function can guide users to directly drawing patterns of the learning piece 81 on the drawing piece 83 placed on the light guide plate 3, and the obtained patterns on the drawing piece 83 is the same as the patterns of the learning piece 81.

4. It is convenient for achieving insertion and draw-out of the learning piece through the input portion.

What are disclosed above are only the preferred embodiments of the present invention. It will be understood by those skilled in the art that various equivalent changes may be made depending on the specification and the drawings of present invention without departing from the scope of the present invention.

What is claimed is:

1. An optical hand drawing plate, comprising:
a body having a concave portion;
a backlight module mounted in the concave portion and having an insertion space; and
a control circuitry for controlling the backlight module, mounted in the body and having a power switch.

2. The optical hand drawing plate as claimed in claim 1, wherein the concave portion includes a bottom and a surrounding portion surrounding the bottom, the surrounding portion has a positioning portion, and the body has an input portion corresponding to the insertion space.

3. The optical hand drawing plate as claimed in claim 2, wherein the backlight module includes:
a light guide plate mounted on the positioning portion;
a background plate mounted in the bottom, the insertion space formed between the background plate and the light guide plate; and
at least one light emitting assembly mounted at one side of the light guide plate.

4. The optical hand drawing plate as claimed in claim 3, further comprising:
a drawing piece disposed on the light guide plate in the concave portion;
a pressing piece mounted in the concave portion and pressing the drawing piece; and
a fixing piece abutting against the light guide plate and having a protruding portion;
wherein the protruding portion engages with a fastening portion of the surrounding portion and the light guide plate is located between the fixing piece and the positioning portion.

5. The optical hand drawing plate as claimed in claim 2, wherein the input portion is a slot with a slot hole, and the slot hole is adjacent to the insertion space.

6. The optical hand drawing plate as claimed in claim 5, further comprising:
a guiding portion mounted in the input portion and connecting with the concave portion, the guiding portion having a guiding plane adjacent to the bottom and a draw-out portion concavely formed at a side of the guiding plane.

7. The optical hand drawing plate as claimed in claim 1, wherein the concave portion includes a bottom and a surrounding portion surrounding the bottom, and the surrounding portion has a positioning portion, and the backlight module includes:
a movable light guide module pivotedly connecting with a side edge of the surrounding portion and being on the positioning portion;
a background plate mounted in the bottom, the insertion space formed between the background plate and the movable light guide module; and
at least one light emitting assembly mounted at a side edge of the surrounding portion, corresponding to the movable light guide module.

8. The optical hand drawing plate as claimed in claim 7, wherein the movable light guide module includes:
a light guide plate; and
a fixing piece fixed on sides of the light guide plate and having a first pivoted end pivotedly connecting with a second pivoted end of the surrounding portion.

9. The optical hand drawing plate as claimed in claim 8, further comprising:
a drawing piece disposed on the light guide plate in the concave portion; and
a pressing piece mounted in the concave portion and pressing the drawing piece.

10. The optical hand drawing plate as claimed in claim 1, further comprising:
a receiving portion inserted in one side of the body;
a holding portion disposed on one side of the body; and
a learning piece inserted in the insertion space, wherein the learning piece is a plastic piece, and patterns on the plastic piece are graphics or characters.
